(19) United States
(12) Patent Application Publication
(10) Pub. No.: US 2019/0114571 A1
(43) Pub. Date: Apr. 18, 2019

(54) SYSTEMS AND METHODS FOR EVALUATING PERSONNEL FOR TASK ASSIGNMENT

(71) Applicant: Vocollect, Inc., Pittsburgh, PA (US)

(72) Inventor: Matthew Aaron Nichols, Pittsburgh, PA (US)

(21) Appl. No.: 15/783,383

(22) Filed: Oct. 13, 2017

(51) Int. Cl. G06Q 10/06

(52) U.S. Cl. CPC G06Q 10/06398; G06Q 10/06311

(57) ABSTRACT

The present disclosure is directed to systems and methods for evaluating workers for executing various types of tasks. As can be appreciated, a worker who is best suited for carrying out a first task requiring a first set of skills may not necessarily be the most suitable for carrying out a second task that requires a different set of skills. Accordingly, a number of workers are evaluated when performing various tasks and the results of the performance evaluations are stored in a database in the form of performance metrics. The performance metrics of each worker and the associated task performed by the worker are linked to each other by using a machine-readable code. The machine-readable code, which can be a stock keeping unit (SKU) code, is used to search the database for retrieving and evaluating the various performance metrics and identifying one or more workers for executing an upcoming task.

### FIELD OF THE INVENTION

The present invention generally relates to task assignment procedures and more particularly relates to systems and methods for evaluating personnel for task assignments.

### BACKGROUND

Goods handling facilities such as product distribution centers, often try to improve efficiency in various aspects of their operations. However, some of these efforts may prove counterproductive if carried out without proper foresight or planning. For example, it may appear intuitive to use a worker who performs his/her tasks very quickly without wasting time chatting with his/her customers. Such an approach may provide an improvement in terms of time. However, the improved efficiency in terms of time may come at the expense of reduced customer satisfaction. On the other hand, using another worker who generates high customer satisfaction as a result of chatting with his/her customers may prove inefficient in terms of an amount of time taken to complete a set of tasks. Thus, identifying the right kind of worker for the right kind of task can prove quite challenging and can lead to poor results if done improperly or inadequately.

### SUMMARY

In an exemplary embodiment in accordance with the disclosure, a method includes evaluating a first worker executing a first task; creating a first performance metric of the first worker for the first task based on the evaluation; utilizing a task assignment system to assign a code to the first task; storing the first performance metric of the first worker in a database of the task assignment system; configuring the database to link the code to the first performance metric of the first worker; and executing a task assignment procedure comprising utilizing the code to search the database and access the first performance metric of the first worker.

In another exemplary embodiment in accordance with the disclosure, a method includes assigning a machine-readable code to a first task; evaluating a first worker executing the first task; creating a first performance metric of the first worker for the first task based on the evaluation; storing the first performance metric of the first worker in a database; configuring the database to associate the machine-readable code with the first performance metric of the first worker; evaluating a second worker executing the first task; creating a second performance metric of the second worker for the first task based on the evaluation; storing the second performance metric of the second worker in the database; configuring the database to associate the machine-readable code with the second performance metric of the second worker; and executing a task assignment procedure. The task assignment procedure comprises utilizing the machine-readable code to search the database and access the first performance metric of the first worker and the second performance metric of the second worker; and utilizing the first performance metric and the second performance metric to evaluate at least one of the first worker or the second worker for executing a second task.

In yet another exemplary embodiment in accordance with the disclosure, a non-transitory computer-readable storage medium contains instructions executable by a processor for performing operations such as receiving at least a first machine-readable code, the first machine-readable code at least indicative of a characteristic of a first object or a characteristic of a first task; utilizing the first machine-readable code to search a database, the database comprising a name of a first worker, a name of a second worker, one or more performance metrics of the first worker, and one or more performance metrics of the second worker; comparing the one or more performance metrics of the first worker to the one or more performance metrics of the second worker; and offering a search result that recommends utilizing one of the first worker or the second worker for at least one of handling the first object or executing the first task.

The foregoing illustrative summary, as well as other exemplary objectives and/or advantages described in this disclosure, and the manner in which the same are accomplished, are further explained within the following detailed description and its accompanying drawings.

### BRIEF DESCRIPTION OF THE DRAWINGS

FIG. 1 schematically depicts two workers when executing a task involving handling of a heavy object.

FIG. 2 schematically depicts the two workers shown in FIG. 1 when executing a task involving handling of a delicate object.

FIG. 3 schematically depicts an exemplary computing system that can be used to implement a task assignment system in accordance with an exemplary embodiment of the disclosure.

FIG. 4 shows a first exemplary database that can be used to execute a task assignment procedure in accordance with the disclosure.

FIG. 5 shows a second exemplary database that can be used to execute a task assignment procedure in accordance with the disclosure.

FIG. 6 shows a third exemplary database that can be used to execute a task assignment procedure in accordance with the disclosure.

### DETAILED DESCRIPTION

Throughout this description, embodiments and variations are described for the purpose of illustrating uses and implementations of inventive concepts. The illustrative description should be understood as presenting examples of inventive concepts, rather than as limiting the scope of the concepts as disclosed herein. Towards this end, certain words and terms are used herein solely for convenience and such words and terms should be broadly understood as encompassing various objects and actions that are generally understood in various forms and equivalencies by persons of ordinary skill in the art. For example, the word “worker” as used herein generally represents a human entity carrying out a task. The word “task” as used herein can be one of a wide variety of tasks and is not limited to any one specific work environment. Furthermore, the word “example” as used herein is intended to be non-exclusionary and non-limiting in nature. More particularly, the word “exemplary” as used herein indicates one among several examples and it should be understood that no special emphasis, exclusivity, or preference, is associated or implied by the use of this word.

The present disclosure is generally directed to systems and methods for evaluating personnel for executing various types of tasks. For example, a first task may entail transporting a heavy object from one location to another, a second task may entail transporting a fragile object from one location to another, a third task may entail completing the task within a short period of time, a fourth task may entail diligence and patience for completing the task, and a fifth task may entail using creativity for completing the task. A worker who may be most suitable for carrying out a first task among these various tasks may not necessarily be the most suitable for carrying out a second task that requires a different set of skills. Thus, in accordance with the various exemplary embodiments described herein, various workers are evaluated when carrying out various tasks and the results of these evaluations are stored in a database. A search for one or more candidates for executing an upcoming task can be carried out by searching the database using machine-readable codes that are assigned to the various tasks and the various evaluations in accordance with the disclosure. These aspects will be described below in further detail.

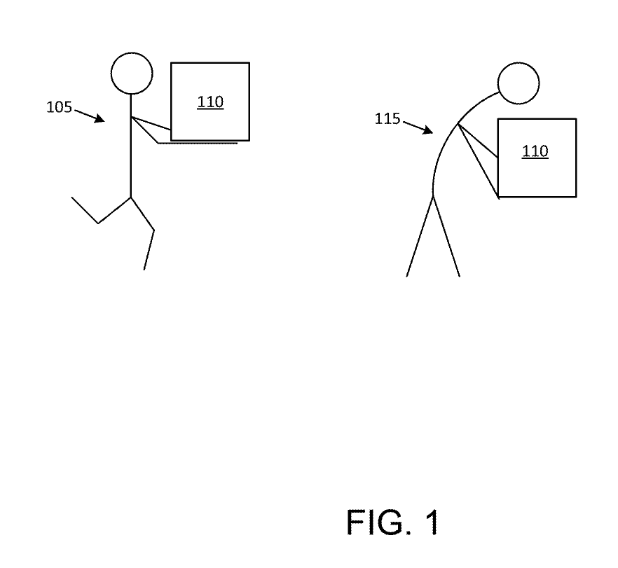

FIG. 1 schematically depicts two workers executing a task that involves handling of a heavy object 110. Worker 105 is physically strong and is capable of transporting the heavy object 110 quickly and easily from a first location to a second location. On the other hand, worker 115 is physically weaker than worker 105 and has to expend a greater amount of effort and takes longer to transport the heavy object 110 from the first location to the second location. If time and effort were the only criteria for comparing worker 105 against worker 115, it is obvious that worker 105 is more suitable than worker 115 for the task of transporting the heavy object 110 from the first location to the second location. However, the suitability of worker 105 for executing the task of transporting the heavy object 110 from the first location to the second location does not necessarily mean that worker 105 would be automatically better than worker 115 for executing a different task having different criteria.

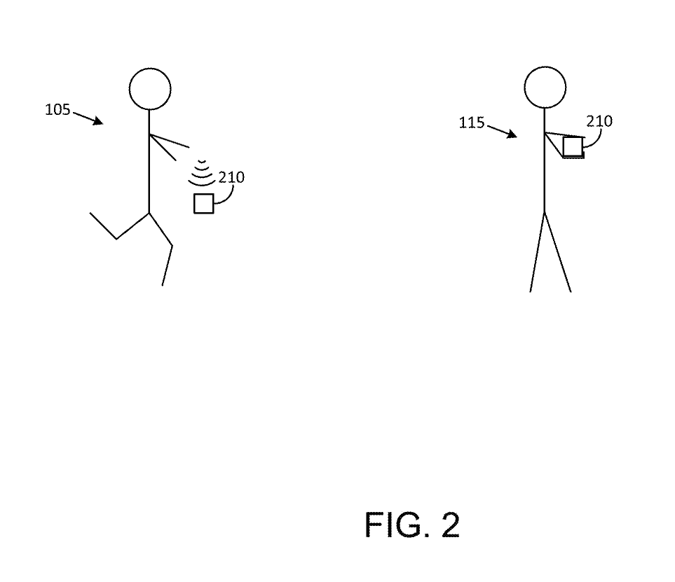

More particularly, FIG. 2 shows worker 105 and worker 115 when transporting a delicate object 210 from the first location to the second location. Playing to his strength, worker 105 attempts to transport the delicate object 210 quickly from the first location to the second location. In doing so, the worker 105 drops the delicate object 210 and causes damage to the object 210. On the other hand, worker 115 carefully and safely transports the delicate object 210 from the first location to the second location even though the worker 115 takes somewhat longer than the worker 105 in executing this task.

It can be appreciated in view of the two exemplary scenarios depicted in FIGS. 1 and 2, that the worker 105 is better suited for tasks requiring lifting of heavy objects and rapid transportation, whereas the worker 115 is better suited for tasks requiring handling of delicate objects.

By extension of the examples provided above, it can be appreciated that each worker of a workforce can have certain skills and capabilities that have to be identified and utilized based on the nature of individual tasks to be performed by the various workers of the workforce. Identifying the skills and capabilities of various workers can become cumbersome and unreliable if carried out, for example, by an individual supervisor in a company. The supervisor has to rely on his/her memory to recollect performance metrics of individual workers when trying to evaluate the workers for executing a new task at a later date. This approach can prove unreliable and inefficient.

Furthermore, the worker performance metrics identified by the individual supervisor can be lost if the supervisor decides to leave the company without entering and storing the worker performance metrics in a computer system of the company prior to leaving the company. The person replacing the supervisor is therefore compelled to carry out a fresh set of observations and evaluations even when one or more of upcoming tasks is exactly the same, or similar to, various tasks that have already been performed by the workers.

However, storing worker performance metrics in a computer system can prove ineffective for use when needed by the replacement supervisor for example, particularly if the amount of information to be stored is large and the information is not properly configured for carrying out searches. For example, poorly stored worker performance metrics may make it difficult or impossible for a new supervisor to identify the strengths and weaknesses of individual workers, particularly when the workers have performed a wide variety of tasks, each task requiring a different set of skills.

Thus, some exemplary systems and methods for storing and retrieving worker performance metrics when evaluating workers for task assignment are described herein in accordance with the disclosure. More particularly, disclosed herein is a data storage and retrieval system that uses machine-readable codes to link worker performance metrics to various task-related parameters. The machine-readable codes not only facilitate easy retrieval of stored worker performance metrics, but also facilitate other activities and functionalities associated with machine-readable codes (such as identifying and/or tracking products). A few examples of machine-readable codes that can be used in accordance with the disclosure include a stock keeping unit (SKU) code and various types of barcodes. As is known, barcodes have evolved over time from one-dimensional (1D) linear barcodes to other types of barcodes (such as a QR code, which is one example of a two-dimensional (2D) matrix barcode).

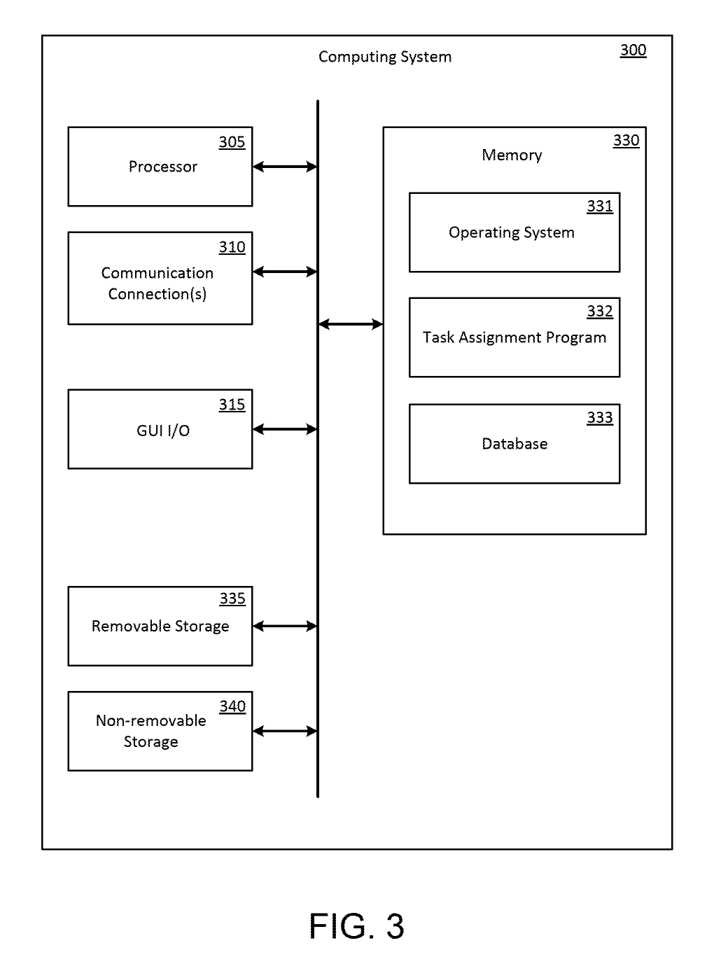

FIG. 3 schematically depicts an exemplary computing system 300 that can be used to implement a task assignment system in accordance with an exemplary embodiment of the disclosure. The computing system 300 can include one or more processors, such as the processor 305 that is configured to communicatively cooperate with a memory 330. The processor 305 can be implemented and operated using appropriate hardware, software, firmware, or combinations thereof. Software or firmware implementations can include computer-executable or machine-executable instructions written in any suitable programming language to perform the various functions described in this disclosure.

The memory 330 can be used to store program instructions that are loadable and executable by the processor 305 as well as to store data generated during the execution of these programs. Depending on the configuration and type of the computing system 300, the memory 330 can be volatile (such as random access memory (RAM)) and/or non-volatile (such as read-only memory (ROM), flash memory, etc.). In some embodiments, the memory devices can also include additional removable storage 335 and/or non-removable storage 340 including, but not limited to, magnetic storage, optical disks, and/or tape storage. The disk drives and their associated computer-readable media can provide non-volatile storage of computer-readable instructions, data structures, program modules, and other data. In some implementations, the memory 330 can include multiple types of memory, such as static random access memory (SRAM), dynamic random access memory (DRAM), or ROM.

The memory 330, the removable storage, and the non-removable storage are all examples of non-transient computer-readable storage media. Such non-transient computer-readable storage media can be implemented in a wide variety of ways that are directed at storage of items such as computer-readable instructions, data structures, and/or program modules. Additional types of non-transient computer storage media that can be present include, but are not limited to, programmable random access memory (PRAM), SRAM, DRAM, ROM, electrically erasable programmable read-only memory (EEPROM), compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can be accessed by the processor 305. Combinations of any of the above should also be included within the scope of non-transient computer-readable storage media.

Turning to the contents of the memory 330, the memory 330 can include, but is not limited to, an operating system (OS) 331 and one or more application programs or services for implementing the features and aspects disclosed herein. Such application programs or services can include a task assignment program 332, and a database 333. The task assignment program 332 can be used to execute some or all of the functions disclosed herein with respect to the task assignment system. The database 333 can be used to store worker performance metrics as well as other data such as machine-readable codes that are linked to various elements of the worker performance metrics.

The computing system 300 can also include elements such as communications connections 310 and a graphical user interface (GUI) input/output 315. The communications connections 310 can be used to communicatively couple the computing system 300 to other components, such as another computing system. The GUI input/output 315 can be used to execute some or all of the functions disclosed herein with respect to the task assignment system.

In one exemplary implementation, the computing system 300 is configured as a server computer. A client computer (not shown) can be communicatively coupled to the server computer by utilizing the communications connection 310. In this configuration, the client computer can initiate and transmit a request to the server computer. The server computer executes a task assignment procedure by accessing the database 333 and/or a database located in the client computer for obtaining worker performance metrics. Interactive communication can take place between the server computer and the client computer during execution of the task assignment procedure and information pertaining to the task assignment procedure can be transmitted by the server computer to the client computer during execution of the procedure and/or upon completion of the procedure.

In another exemplary implementation, the computing system 300 is configured as a client computer. A server computer (not shown) can be communicatively coupled to the client computer by utilizing the communications connection 310. In this configuration, the server computer can initiate and transmit a request to the client computer. The client computer can execute a task assignment procedure by accessing the database 333 and/or a database located in the server computer for obtaining worker performance metrics. Interactive communication can take place between the client computer and the server computer during execution of the task assignment procedure and information pertaining to the task assignment procedure can be transmitted by the client computer to the server computer during execution of the procedure and/or upon completion of the procedure.

In another exemplary implementation, the computing system 300 is configured to utilize cloud storage in addition to, or in lieu of, using local storage such as the database 333, removable storage 335, and non-removable storage 340. Accordingly, the computing system 300 utilizes the communications connection 310 to communicate with a network such as the Internet and execute a task assignment procedure in accordance with the disclosure. The cloud storage can be used for storing data that is not only relevant to workers in a particular work facility at a particular location but can include workers from various facilities at various other locations. Consequently, the computing system 300 can be used to execute task assignment procedures for evaluating workers on a world-wide basis and assign specific workers to execute specific tasks at various locations of a multinational corporation, for example.

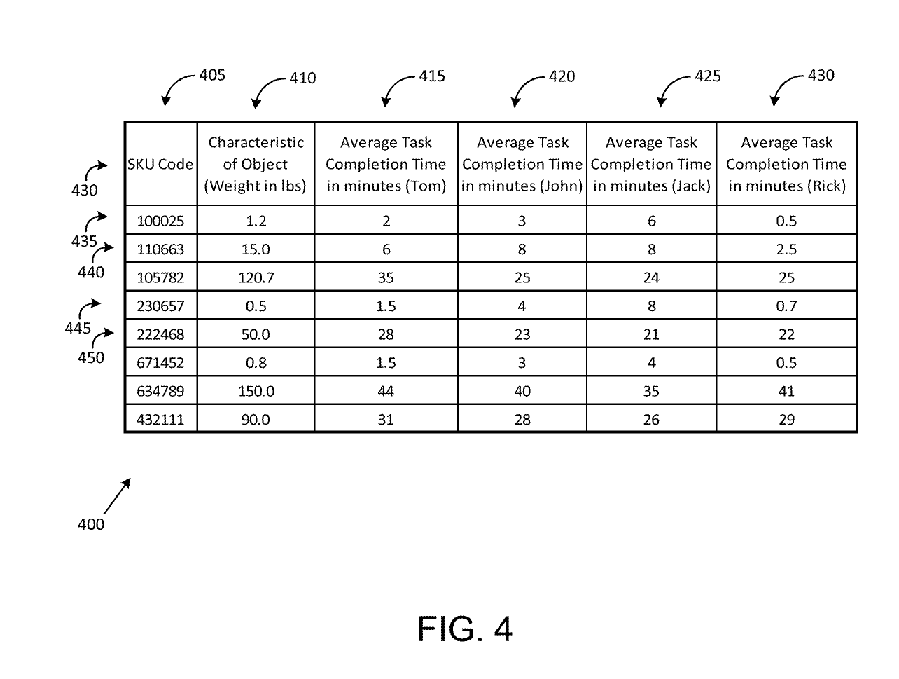

FIG. 4 shows a first exemplary database 400 that can be used to execute a task assignment procedure in accordance with the disclosure. The first exemplary database 400 includes a header row 430 and several other rows below the header row 430. A first column 405 of the first exemplary database 400 contains various exemplary machine-readable codes (SKU codes in this example). The SKU codes can be assigned by various entities, such as a supervisor of a work facility or an administrator associated with the work facility. The assignment involves using a task assignment system (such as the computing system 300 described above) to assign a unique SKU code to each task. Thus, an exemplary SKU code 100025 shown in the first row 435 of the first exemplary database 400 is assigned to a first task, the exemplary SKU code 110663 shown in the second row 440 of the first exemplary database 400 is assigned to a second task, and so on.

The first exemplary database 400 includes a second column 410 that contains information pertaining to a characteristic of an object that is handled by a worker assigned to a task. In this example, the characteristic is a weight of an object in pounds. Column 410 shows a data entry in the first row 435 which indicates that the weight of a first object handled by a worker assigned to the first task is 1.2 pounds, a data entry in the second row 440 which indicates that the weight of a second object handled by the worker when assigned to the second task is 15.0 pounds, and so on.

The various objects listed in the second column 410 are linked to the corresponding SKU codes listed in the first column 405 in accordance with the disclosure. In one exemplary implementation, the task assignment system automatically links each individual object to a corresponding SKU code. Thus, the object weighing 15 pounds is automatically linked to the SKU code 110663 and so on. In another exemplary implementation, a human entity (such as an administrator) uses the task assignment system to link each individual object to a corresponding SKU code.

After the linking is carried out, any of the SKU codes of the first exemplary database 400 can be used to conduct a search for information pertaining to the characteristic of an object associated with a specific task. Consequently, using a SKU code 222468 (fifth row 450) as a search term for conducting an exemplary search of the first exemplary database 400 provides a search result that the object associated with the fifth task weighs 50.0 pounds.

The first exemplary database 400 includes a third column 415 that contains performance metrics pertaining to a first worker, Tom, who has executed each of the tasks represented by the SKU codes shown in the first column 405. In this example, the performance metric pertains to an amount of time taken by Tom to complete each task. Tom has executed the first task (involving the handling of an object weighing 1.2 pounds) in 2 minutes, the second task (involving the handling of an object weighing 15.0 pounds) in 6 minutes, and so on. The third column 415 can be populated with Tom's performance metrics obtained by evaluating Tom when executing each of the various tasks. The evaluation can be carried out for example, by a supervisor of a work facility in which Tom is employed. For doing so, the supervisor uses the task assignment system (such as the computing system 300 described above) to link each of Tom's performance metrics to a corresponding SKU code.

Any of the SKU codes of the first exemplary database 400 can be used to conduct a search for information pertaining to one or more tasks executed by Tom. Consequently, using a SKU code 222468 (fifth row 450) for conducting an exemplary search of the first exemplary database 400 provides an indication that Tom completed the fifth task (which involved handling an object weighing 50.0 pounds) in 28 minutes.

The first exemplary database 400 further includes additional columns 420, 425, and 430, that provide performance metrics of other workers who have executed each of the tasks represented by the SKU codes shown in column 405. The additional columns are populated in a manner similar to that described above with reference to column 410.

Any of the SKU codes of the first exemplary database 400 can be used to conduct a search for information pertaining to any one or more workers associated with a specific task. Obtaining information pertaining to two or more workers allows for a comparison to be made (by a supervisor, for example) to evaluate one or more of the workers to perform an upcoming task that may or may not be similar to the tasks included in the first exemplary database 400.

Consequently, using a SKU code 222468 (fifth row 450) for conducting a search of the first exemplary database 400 provides an indication that Tom completed the fifth task (which involved handling an object weighing 50.0 pounds) in 28 minutes whereas a third worker, Jack (column 425), completed the fifth task faster than Tom in 21 minutes. Based on the search result, the supervisor can make an informed decision to use Jack for an upcoming task that involves rapidly handling an object weighing about 50 pounds (60 pounds, for example).

On the other hand, a search of the first exemplary database 400 by using a SKU code 230657 (fourth row 445), would indicate via column 430 that another worker, Rick, would be most suitable for rapidly executing an upcoming task that involves handling an object weighing less than a pound. Thus, in accordance with the disclosure, a task assignment procedure that utilizes a database such as the first exemplary database 400 can allow for comparing a first performance metric of a first worker to a second performance metric of a second worker for executing a second task. In one exemplary implementation, the second may be defined by a numerical value indicative of a level of difficulty of executing the second task.

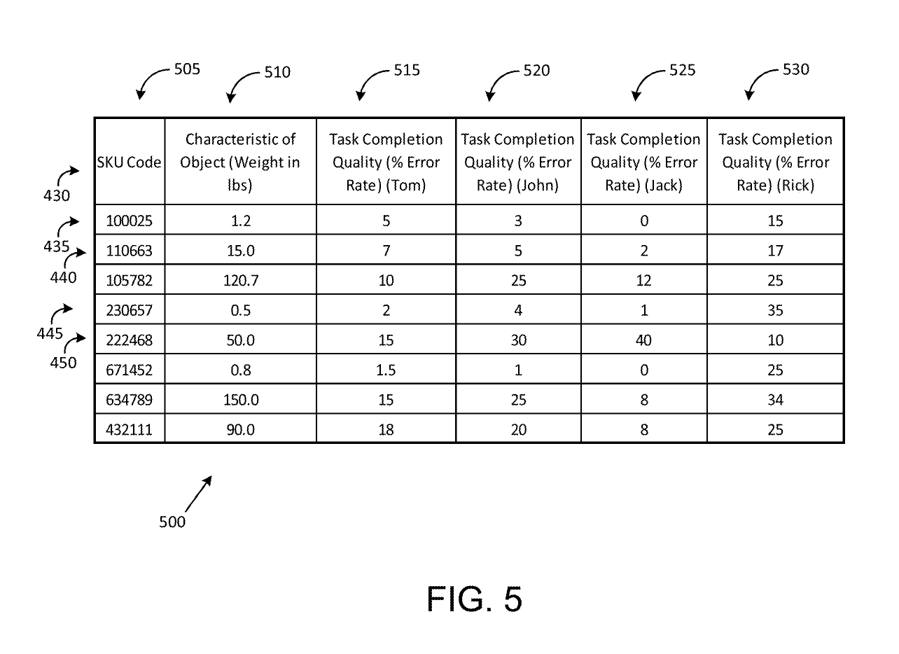

FIG. 5 shows a second exemplary database 500 that can be used to execute a task assignment procedure in accordance with the disclosure. While the first exemplary database 400 described above can be useful for identifying who among a set of workers works fastest on completing various tasks involving handling objects of various weights, the second exemplary database 500 can be used for obtaining information about the quality of the work performed by the various workers during execution of the various tasks.

As can be appreciated from the description above with reference to FIGS. 1 and 2, speed of completion of a task may be merely one criterion for evaluating one or more workers for upcoming tasks. Consequently, in an exemplary implementation, the second exemplary database 500 can be merged with the first exemplary database 400 into a single integrated database that accommodates search procedures that provide time information as well as work quality information of the various workers executing the various tasks. An integrated database that contains data from the first exemplary database 400 and the second exemplary database 500 allows a human entity, such as a supervisor, to carry out a SKU code based search and identify the most suitable worker(s) based on an informed decision incorporating a trade-off between speed of task completion and task completion quality.

The second exemplary database 500 includes a header row 530 and several other rows below the header row 530. In this exemplary implementation, each of a first column 505 and a second column 510 of the second exemplary database 500 is identical to a respective one of the first column 405 and the second column 410 of the first exemplary database 400, thereby allowing for easy merger of the two databases if desired.

However, a third column 515 of the second exemplary database 500 contains information pertaining to a task completion quality of the first worker (Tom), a fourth column 520 contains information pertaining to a task completion quality of the second worker (John), and so on (of the same workers as indicated in the first exemplary database 400). In this example, the task completion quality is indicated by a percentage error rate. The percentage error rate can be based on an amount of deviation from one or more work-quality standards.

In other implementations, the task completion quality can be indicated using other parameters such as customer satisfaction ratings (when the task involves interaction with a customer) and manufactured product quality (when the task involves manufacturing an object).

As described above, using the SKU code 222468 (fifth row 450) for conducting a search of the first exemplary database 400 provided a search result that led the supervisor to make an informed decision to use Jack for an upcoming task that involves handling an object weighing about 50 pounds. However, upon using the same SKU code 222468 (fifth row 450) for conducting a search of the second exemplary database 500 provides an indication to the supervisor that Jack has a 40% error rate when executing the task, which may be an unacceptable indication of task completion quality when compared against a work-quality standard. Based on the task completion quality information obtained from searching the second exemplary database 500 in conjunction with the searching the first exemplary database 400, allows the supervisor to make a more informed decision to use a worker other than Jack for the upcoming task. Selecting a worker in this manner, allows for a combination of factors to be taken into consideration when selecting a worker for an upcoming task.

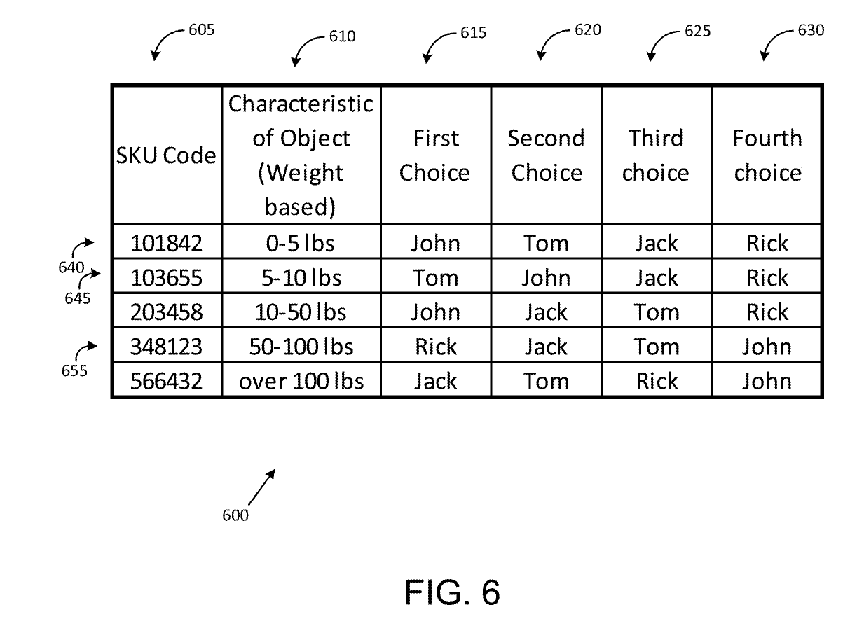

FIG. 6 shows a third exemplary database 600 that can be used to execute a task assignment procedure in accordance with the disclosure. As described above, a combination of information obtained by searching the first exemplary database 400 and the second exemplary database 500 provided information to recognize that Jack was not necessarily the best choice for executing the upcoming task. The third exemplary database 600 can be generated by a human entity such as an administrator or the supervisor, based on the supervisor's recommendations after using the first exemplary database 400 and the second exemplary database 500 (plus one or more other databases (not shown) if so desired). The third exemplary database 600 provides information pertaining to a preferential order of selection among workers for executing tasks based on the characteristics of various objects (in this example, a weight class of various objects). In other embodiments, the various objects can be characterized using parameters other than a weight parameter, such as a size parameter, a portability parameter, and/or a damage resistance parameter.

In accordance with this exemplary embodiment, a first column 605 of the third exemplary database 600 contains various exemplary machine-readable codes (exemplary SKU codes in this example). The SKU codes can be assigned by various entities, such as a supervisor of a work facility or an administrator associated with the work facility. The assignment involves using a task assignment system (such as the computing system 300 described above) to assign a unique SKU code to each task based on a weight class of an object handled during execution of the task.

Thus, the SKU code 101842 shown in the first row 640 of the third exemplary database 600 is assigned to a first weight class (0 to 5 pounds) of an object handled during execution of a first task, the SKU code 103655 shown in the second row 645 of the third exemplary database 600 is assigned to a second weight class (5 to 10 pounds) of an object handled during execution of a second task, and so on. The second column 610 of the third exemplary database 600 indicates various exemplary weight classes of various objects that can be handled during execution of various tasks.

In one exemplary implementation, each of the SKU codes shown in the first column 605 of the third exemplary database 600 can be linked to the SKU codes in the first column 405 of the first exemplary database 400 and/or the first column 505 of the second exemplary database 500.

Thus, in a first exemplary implementation, two or more of the first exemplary database 400, the second exemplary database 500, and the third exemplary database 600 can be merged into a single integrated database that provides information based on a search using one or both of the linked SKU codes.

However, in a second exemplary implementation, each of the SKU codes shown in the first column 605 of the third exemplary database 600 can be independent of the SKU codes used in one or both of the first exemplary database 400 and the second exemplary database 500 and the third exemplary database 600 can be used independent of the first exemplary database 400 and the second exemplary database 500.

A third column 615 of the third exemplary database 600 provides an indication of a first choice of a worker for each weight class indicated in the first column 610, a fourth column 620 of the third exemplary database 600 provides an indication of a second choice of worker for each weight class indicated in the first column 610, and so on. Each of the entries in columns 610, 615, 620, 625, and 630 is linked to each of the entries in the first column 605 and the second column 610 such that a search of the third exemplary database 600 using one of the SKU codes shown in the first column 605 provides corresponding information corresponding to the SKU code.

Thus, for example, a search of the third exemplary database 600 using a SKU code 348123 (fourth row 655) provides information that indicates Rick is a first choice for handing an object weighing between 50 and 100 pounds, Jack is a second choice for handling a similar object, and so on.

In other exemplary embodiments, a search of one or more databases such as the first exemplary database 400, the second exemplary database 500, and the third exemplary database 600, can be carried out using search terms other than a SKU code. For example, a database can be searched using the name of a worker and/or a characteristic of an object. Accordingly, a search of the first exemplary database 400 by using the worker name Tom would not only provide information pertaining to Tom's average task completion time but will also provide information pertaining to the SKU codes of the various tasks executed by Tom. The SKU codes revealed by this search can then be used for example to identify other workers who have worked on the tasks associated with the various SKU codes and can also be used to compare the performance characteristics of Tom against other workers.

To supplement the present disclosure, this application incorporates entirely by reference the following commonly assigned patents, patent application publications, and patent applications:
U.S. Pat. Nos. 6,832,725; 7,128,266;
U.S. Pat. Nos. 7,159,783; 7,413,127;
U.S. Pat. Nos. 7,726,575; 8,294,969;
U.S. Pat. Nos. 8,317,105; 8,322,622;
U.S. Pat. Nos. 8,366,005; 8,371,507;
U.S. Pat. Nos. 8,376,233; 8,381,979;
U.S. Pat. Nos. 8,390,909; 8,408,464;
U.S. Pat. Nos. 8,408,468; 8,408,469;
U.S. Pat. Nos. 8,424,768; 8,448,863;
U.S. Pat. Nos. 8,457,013; 8,459,557;
U.S. Pat. Nos. 8,469,272; 8,474,712;
U.S. Pat. Nos. 8,479,992; 8,490,877;
U.S. Pat. Nos. 8,517,271; 8,523,076;
U.S. Pat. Nos. 8,528,818; 8,544,737;
U.S. Pat. Nos. 8,548,242; 8,548,420;
U.S. Pat. Nos. 8,550,335; 8,550,354;
U.S. Pat. Nos. 8,550,357; 8,556,174;
U.S. Pat. Nos. 8,556,176; 8,556,177;
U.S. Pat. Nos. 8,559,767; 8,599,957;
U.S. Pat. Nos. 8,561,895; 8,561,903;
U.S. Pat. Nos. 8,561,905; 8,565,107;
U.S. Pat. Nos. 8,571,307; 8,579,200;
U.S. Pat. Nos. 8,583,924; 8,584,945;
U.S. Pat. Nos. 8,587,595; 8,587,697;
U.S. Pat. Nos. 8,588,869; 8,590,789;
U.S. Pat. Nos. 8,596,539; 8,596,542;
U.S. Pat. Nos. 8,596,543; 8,599,271;
U.S. Pat. Nos. 8,599,957; 8,600,158;
U.S. Pat. Nos. 8,600,167; 8,602,309;
U.S. Pat. Nos. 8,608,053; 8,608,071;
U.S. Pat. Nos. 8,611,309; 8,615,487;
U.S. Pat. Nos. 8,616,454; 8,621,123;
U.S. Pat. Nos. 8,622,303; 8,628,013;
U.S. Pat. Nos. 8,628,015; 8,628,016;
U.S. Pat. Nos. 8,629,926; 8,630,491;
U.S. Pat. Nos. 8,635,309; 8,636,200;
U.S. Pat. Nos. 8,636,212; 8,636,215;
U.S. Pat. Nos. 8,636,224; 8,638,806;
U.S. Pat. Nos. 8,640,958; 8,640,960;
U.S. Pat. Nos. 8,643,717; 8,646,692;
U.S. Pat. Nos. 8,646,694; 8,657,200;
U.S. Pat. Nos. 8,659,397; 8,668,149;
U.S. Pat. Nos. 8,678,285; 8,678,286;
U.S. Pat. Nos. 8,682,077; 8,687,282;
U.S. Pat. Nos. 8,692,927; 8,695,880;
U.S. Pat. Nos. 8,698,949; 8,717,494;
U.S. Pat. Nos. 8,717,494; 8,720,783;
U.S. Pat. Nos. 8,723,804; 8,723,904;
U.S. Pat. Nos. 8,727,223; 8,740,082;
U.S. Pat. Nos. 8,740,085; 8,746,563;
U.S. Pat. Nos. 8,750,445; 8,752,766;
U.S. Pat. Nos. 8,756,059; 8,757,495;
U.S. Pat. Nos. 8,760,563; 8,763,909;
U.S. Pat. Nos. 8,777,108; 8,777,109;
U.S. Pat. Nos. 8,779,898; 8,781,520;
U.S. Pat. Nos. 8,783,573; 8,789,757;
U.S. Pat. Nos. 8,789,758; 8,789,759;
U.S. Pat. Nos. 8,794,520; 8,794,522;
U.S. Pat. Nos. 8,794,525; 8,794,526;
U.S. Pat. Nos. 8,798,367; 8,807,431;
U.S. Pat. Nos. 8,807,432; 8,820,630;
U.S. Pat. Nos. 8,822,848; 8,824,692;
U.S. Pat. Nos. 8,824,696; 8,842,849;
U.S. Pat. Nos. 8,844,822; 8,844,823;
U.S. Pat. Nos. 8,849,019; 8,851,383;
U.S. Pat. Nos. 8,854,633; 8,866,963;
U.S. Pat. Nos. 8,868,421; 8,868,519;
U.S. Pat. Nos. 8,868,802; 8,868,803;
U.S. Pat. Nos. 8,870,074; 8,879,639;
U.S. Pat. Nos. 8,880,426; 8,881,983;
U.S. Pat. Nos. 8,881,987; 8,903,172;
U.S. Pat. Nos. 8,908,995; 8,910,870;
U.S. Pat. Nos. 8,910,875; 8,914,290;
U.S. Pat. Nos. 8,914,788; 8,915,439;
U.S. Pat. Nos. 8,915,444; 8,916,789;
U.S. Pat. Nos. 8,918,250; 8,918,564;
U.S. Pat. Nos. 8,925,818; 8,939,374;
U.S. Pat. Nos. 8,942,480; 8,944,313;
U.S. Pat. Nos. 8,944,327; 8,944,332;
U.S. Pat. Nos. 8,950,678; 8,967,468;
U.S. Pat. Nos. 8,971,346; 8,976,030;
U.S. Pat. Nos. 8,976,368; 8,978,981;
U.S. Pat. Nos. 8,978,983; 8,978,984;
U.S. Pat. Nos. 8,985,456; 8,985,457;
U.S. Pat. Nos. 8,985,459; 8,985,461;
U.S. Pat. Nos. 8,988,578; 8,988,590;
U.S. Pat. Nos. 8,991,704; 8,996,194;
U.S. Pat. Nos. 8,996,384; 9,002,641;
U.S. Pat. Nos. 9,007,368; 9,010,641;
U.S. Pat. Nos. 9,015,513; 9,016,576;
U.S. Pat. Nos. 9,022,288; 9,030,964;
U.S. Pat. Nos. 9,033,240; 9,033,242;
U.S. Pat. Nos. 9,036,054; 9,037,344;
U.S. Pat. Nos. 9,038,911; 9,038,915;
U.S. Pat. Nos. 9,047,098; 9,047,359;
U.S. Pat. Nos. 9,047,420; 9,047,525;
U.S. Pat. Nos. 9,047,531; 9,053,055;
U.S. Pat. Nos. 9,053,378; 9,053,380;
U.S. Pat. Nos. 9,058,526; 9,064,165;
U.S. Pat. Nos. 9,064,165; 9,064,167;
U.S. Pat. Nos. 9,064,168; 9,064,254;
U.S. Pat. Nos. 9,066,032; 9,070,032;
U.S. Pat. Nos. 9,076,459; 9,079,423;
U.S. Pat. Nos. 9,080,856; 9,082,023;
U.S. Pat. Nos. 9,082,031; 9,084,032;
U.S. Pat. Nos. 9,087,250; 9,092,681;
U.S. Pat. Nos. 9,092,682; 9,092,683;
U.S. Pat. Nos. 9,093,141; 9,098,763;
U.S. Pat. Nos. 9,104,929; 9,104,934;
U.S. Pat. Nos. 9,107,484; 9,111,159;
U.S. Pat. Nos. 9,111,166; 9,135,483;
U.S. Pat. Nos. 9,137,009; 9,141,839;
U.S. Pat. Nos. 9,147,096; 9,148,474;
U.S. Pat. Nos. 9,158,000; 9,158,340;
U.S. Pat. Nos. 9,158,953; 9,159,059;
U.S. Pat. Nos. 9,165,174; 9,171,543;
U.S. Pat. Nos. 9,183,425; 9,189,669;
U.S. Pat. Nos. 9,195,844; 9,202,458;
U.S. Pat. Nos. 9,208,366; 9,208,367;
U.S. Pat. Nos. 9,219,836; 9,224,024;
U.S. Pat. Nos. 9,224,027; 9,230,140;
U.S. Pat. Nos. 9,235,553; 9,239,950;
U.S. Pat. Nos. 9,245,492; 9,248,640;
U.S. Pat. Nos. 9,250,652; 9,250,712;
U.S. Pat. Nos. 9,251,411; 9,258,033;
U.S. Pat. Nos. 9,262,633; 9,262,660;
U.S. Pat. Nos. 9,262,662; 9,269,036;
U.S. Pat. Nos. 9,270,782; 9,274,812;
U.S. Pat. Nos. 9,275,388; 9,277,668;
U.S. Pat. Nos. 9,280,693; 9,286,496;
U.S. Pat. Nos. 9,298,964; 9,301,427;
U.S. Pat. Nos. 9,313,377; 9,317,037;
U.S. Pat. Nos. 9,319,548; 9,342,723;
U.S. Pat. Nos. 9,361,882; 9,365,381;
U.S. Pat. Nos. 9,373,018; 9,375,945;
U.S. Pat. Nos. 9,378,403; 9,383,848;
U.S. Pat. Nos. 9,384,374; 9,390,304;
U.S. Pat. Nos. 9,390,596; 9,411,386;
U.S. Pat. Nos. 9,412,242; 9,418,269;
U.S. Pat. Nos. 9,418,270; 9,465,967;
U.S. Pat. Nos. 9,423,318; 9,424,454;
U.S. Pat. Nos. 9,436,860; 9,443,123;
U.S. Pat. Nos. 9,443,222; 9,454,689;
U.S. Pat. Nos. 9,464,885; 9,465,967;
U.S. Pat. Nos. 9,478,983; 9,481,186;
U.S. Pat. Nos. 9,487,113; 9,488,986;
U.S. Pat. Nos. 9,489,782; 9,490,540;
U.S. Pat. Nos. 9,491,729; 9,497,092;
U.S. Pat. Nos. 9,507,974; 9,519,814;
U.S. Pat. Nos. 9,521,331; 9,530,038;
U.S. Pat. Nos. 9,572,901; 9,558,386;
U.S. Pat. Nos. 9,606,581; 9,646,189;
U.S. Pat. Nos. 9,646,191; 9,652,648;
U.S. Pat. Nos. 9,652,653; 9,656,487;
U.S. Pat. Nos. 9,659,198; 9,680,282;
U.S. Pat. Nos. 9,697,401; 9,701,140;
U.S. Design Pat. No. D702,237;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D734,339;
U.S. Design Pat. No. D737,321;
U.S. Design Pat. No. D754,205;
U.S. Design Pat. No. D754,206;
U.S. Design Pat. No. D757,009;
U.S. Design Pat. No. D760,719;
U.S. Design Pat. No. D762,604;
U.S. Design Pat. No. D766,244;
U.S. Design Pat. No. D777,166;
U.S. Design Pat. No. D771,631;
U.S. Design Pat. No. D783,601;
U.S. Design Pat. No. D785,617;
U.S. Design Pat. No. D785,636;
U.S. Design Pat. No. D790,505;
U.S. Design Pat. No. D790,546;
International Publication No. 2013/163789;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0194692;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0332996;
U.S. Patent Application Publication No. 2014/0001267;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131443;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0191684;
U.S. Patent Application Publication No. 2014/0191913;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0231500;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0332590;
U.S. Patent Application Publication No. 2014/0351317;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0009338;
U.S. Patent Application Publication No. 2015/0014416;
U.S. Patent Application Publication No. 2015/0021397;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0049347;
U.S. Patent Application Publication No. 2015/0051992;
U.S. Patent Application Publication No. 2015/0053769;
U.S. Patent Application Publication No. 2015/0062366;
U.S. Patent Application Publication No. 2015/0063215;
U.S. Patent Application Publication No. 2015/0088522;
U.S. Patent Application Publication No. 2015/0096872;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0149946;
U.S. Patent Application Publication No. 2015/0161429;
U.S. Patent Application Publication No. 2015/0178523;
U.S. Patent Application Publication No. 2015/0178537;
U.S. Patent Application Publication No. 2015/0178685;
U.S. Patent Application Publication No. 2015/0181109;
U.S. Patent Application Publication No. 2015/0199957;
U.S. Patent Application Publication No. 2015/0210199;
U.S. Patent Application Publication No. 2015/0212565;
U.S. Patent Application Publication No. 2015/0213647;
U.S. Patent Application Publication No. 2015/0220753;
U.S. Patent Application Publication No. 2015/0220901;
U.S. Patent Application Publication No. 2015/0227189;
U.S. Patent Application Publication No. 2015/0236984;
U.S. Patent Application Publication No. 2015/0239348;
U.S. Patent Application Publication No. 2015/0242658;
U.S. Patent Application Publication No. 2015/0248572;
U.S. Patent Application Publication No. 2015/0254485;
U.S. Patent Application Publication No. 2015/0261643;
U.S. Patent Application Publication No. 2015/0264624;
U.S. Patent Application Publication No. 2015/0268971;
U.S. Patent Application Publication No. 2015/0269402;
U.S. Patent Application Publication No. 2015/0288689;
U.S. Patent Application Publication No. 2015/0288896;
U.S. Patent Application Publication No. 2015/0310243;
U.S. Patent Application Publication No. 2015/0310244;
U.S. Patent Application Publication No. 2015/0310389;
U.S. Patent Application Publication No. 2015/0312780;
U.S. Patent Application Publication No. 2015/0327012;
U.S. Patent Application Publication No. 2016/0014251;
U.S. Patent Application Publication No. 2016/0025697;
U.S. Patent Application Publication No. 2016/0026838;
U.S. Patent Application Publication No. 2016/0026839;
U.S. Patent Application Publication No. 2016/0040982;
U.S. Patent Application Publication No. 2016/0042241;
U.S. Patent Application Publication No. 2016/0057230;
U.S. Patent Application Publication No. 2016/0062473;
U.S. Patent Application Publication No. 2016/0070944;
U.S. Patent Application Publication No. 2016/0092805;
U.S. Patent Application Publication No. 2016/0101936;
U.S. Patent Application Publication No. 2016/0104019;
U.S. Patent Application Publication No. 2016/0104274;
U.S. Patent Application Publication No. 2016/0109219;
U.S. Patent Application Publication No. 2016/0109220;
U.S. Patent Application Publication No. 2016/0109224;
U.S. Patent Application Publication No. 2016/0112631;
U.S. Patent Application Publication No. 2016/0112643;
U.S. Patent Application Publication No. 2016/0117627;
U.S. Patent Application Publication No. 2016/0124516;
U.S. Patent Application Publication No. 2016/0125217;
U.S. Patent Application Publication No. 2016/0125342;
U.S. Patent Application Publication No. 2016/0125873;
U.S. Patent Application Publication No. 2016/0133253;
U.S. Patent Application Publication No. 2016/0171597;
U.S. Patent Application Publication No. 2016/0171666;
U.S. Patent Application Publication No. 2016/0171720;
U.S. Patent Application Publication No. 2016/0171775;
U.S. Patent Application Publication No. 2016/0171777;
U.S. Patent Application Publication No. 2016/0174674;
U.S. Patent Application Publication No. 2016/0178479;
U.S. Patent Application Publication No. 2016/0178685;
U.S. Patent Application Publication No. 2016/0178707;
U.S. Patent Application Publication No. 2016/0179132;
U.S. Patent Application Publication No. 2016/0179143;
U.S. Patent Application Publication No. 2016/0179368;
U.S. Patent Application Publication No. 2016/0179378;
U.S. Patent Application Publication No. 2016/0180130;
U.S. Patent Application Publication No. 2016/0180133;
U.S. Patent Application Publication No. 2016/0180136;
U.S. Patent Application Publication No. 2016/0180594;
U.S. Patent Application Publication No. 2016/0180663;
U.S. Patent Application Publication No. 2016/0180678;
U.S. Patent Application Publication No. 2016/0180713;
U.S. Patent Application Publication No. 2016/0185136;
U.S. Patent Application Publication No. 2016/0185291;
U.S. Patent Application Publication No. 2016/0186926;
U.S. Patent Application Publication No. 2016/0188861;
U.S. Patent Application Publication No. 2016/0188939;
U.S. Patent Application Publication No. 2016/0188940;
U.S. Patent Application Publication No. 2016/0188941;
U.S. Patent Application Publication No. 2016/0188942;
U.S. Patent Application Publication No. 2016/0188943;
U.S. Patent Application Publication No. 2016/0188944;
U.S. Patent Application Publication No. 2016/0189076;
U.S. Patent Application Publication No. 2016/0189087;
U.S. Patent Application Publication No. 2016/0189088;
U.S. Patent Application Publication No. 2016/0189092;
U.S. Patent Application Publication No. 2016/0189284;
U.S. Patent Application Publication No. 2016/0189288;
U.S. Patent Application Publication No. 2016/0189366;
U.S. Patent Application Publication No. 2016/0189443;
U.S. Patent Application Publication No. 2016/0189447;
U.S. Patent Application Publication No. 2016/0189489;
U.S. Patent Application Publication No. 2016/0192051;
U.S. Patent Application Publication No. 2016/0202951;
U.S. Patent Application Publication No. 2016/0202958;
U.S. Patent Application Publication No. 2016/0202959;
U.S. Patent Application Publication No. 2016/0203021;
U.S. Patent Application Publication No. 2016/0203429;
U.S. Patent Application Publication No. 2016/0203797;
U.S. Patent Application Publication No. 2016/0203820;
U.S. Patent Application Publication No. 2016/0204623;
U.S. Patent Application Publication No. 2016/0204636;
U.S. Patent Application Publication No. 2016/0204638;
U.S. Patent Application Publication No. 2016/0227912;
U.S. Patent Application Publication No. 2016/0232891;
U.S. Patent Application Publication No. 2016/0292477;
U.S. Patent Application Publication No. 2016/0294779;
U.S. Patent Application Publication No. 2016/0306769;
U.S. Patent Application Publication No. 2016/0314276;
U.S. Patent Application Publication No. 2016/0314294;
U.S. Patent Application Publication No. 2016/0316190;
U.S. Patent Application Publication No. 2016/0323310;
U.S. Patent Application Publication No. 2016/0325677;
U.S. Patent Application Publication No. 2016/0327614;
U.S. Patent Application Publication No. 2016/0327930;
U.S. Patent Application Publication No. 2016/0328762;
U.S. Patent Application Publication No. 2016/0330218;
U.S. Patent Application Publication No. 2016/0343163;
U.S. Patent Application Publication No. 2016/0343176;
U.S. Patent Application Publication No. 2016/0364914;
U.S. Patent Application Publication No. 2016/0370220;
U.S. Patent Application Publication No. 2016/0372282;
U.S. Patent Application Publication No. 2016/0373847;
U.S. Patent Application Publication No. 2016/0377414;
U.S. Patent Application Publication No. 2016/0377417;
U.S. Patent Application Publication No. 2017/0010141;
U.S. Patent Application Publication No. 2017/0010328;
U.S. Patent Application Publication No. 2017/0010780;
U.S. Patent Application Publication No. 2017/0016714;
U.S. Patent Application Publication No. 2017/0018094;
U.S. Patent Application Publication No. 2017/0046603;
U.S. Patent Application Publication No. 2017/0047864;
U.S. Patent Application Publication No. 2017/0053146;
U.S. Patent Application Publication No. 2017/0053147;
U.S. Patent Application Publication No. 2017/0053647;
U.S. Patent Application Publication No. 2017/0055606;
U.S. Patent Application Publication No. 2017/0060316;
U.S. Patent Application Publication No. 2017/0061961;
U.S. Patent Application Publication No. 2017/0064634;
U.S. Patent Application Publication No. 2017/0083730;
U.S. Patent Application Publication No. 2017/0091502;
U.S. Patent Application Publication No. 2017/0091706;
U.S. Patent Application Publication No. 2017/0091741;
U.S. Patent Application Publication No. 2017/0091904;
U.S. Patent Application Publication No. 2017/0092908;
U.S. Patent Application Publication No. 2017/0094238;
U.S. Patent Application Publication No. 2017/0098947;
U.S. Patent Application Publication No. 2017/0100949;
U.S. Patent Application Publication No. 2017/0108838;
U.S. Patent Application Publication No. 2017/0108895;
U.S. Patent Application Publication No. 2017/0118355;
U.S. Patent Application Publication No. 2017/0123598;
U.S. Patent Application Publication No. 2017/0124369;
U.S. Patent Application Publication No. 2017/0124396;
U.S. Patent Application Publication No. 2017/0124687;
U.S. Patent Application Publication No. 2017/0126873;
U.S. Patent Application Publication No. 2017/0126904;
U.S. Patent Application Publication No. 2017/0139012;
U.S. Patent Application Publication No. 2017/0140329;
U.S. Patent Application Publication No. 2017/0140731;
U.S. Patent Application Publication No. 2017/0147847;
U.S. Patent Application Publication No. 2017/0150124;
U.S. Patent Application Publication No. 2017/0169198;
U.S. Patent Application Publication No. 2017/0171035;
U.S. Patent Application Publication No. 2017/0171703;
U.S. Patent Application Publication No. 2017/0171803;
U.S. Patent Application Publication No. 2017/0180359;
U.S. Patent Application Publication No. 2017/0180577;
U.S. Patent Application Publication No. 2017/0181299;
U.S. Patent Application Publication No. 2017/0190192;
U.S. Patent Application Publication No. 2017/0193432;
U.S. Patent Application Publication No. 2017/0193461;
U.S. Patent Application Publication No. 2017/0193727;
U.S. Patent Application Publication No. 2017/0199266;
U.S. Patent Application Publication No. 2017/0200108; and
U.S. Patent Application Publication No. 2017/0200275.

In the specification and/or figures, exemplary embodiments of the invention have been disclosed. The present disclosure is not limited to such exemplary embodiments. For example, it should be understood that a printer is merely one example of a device in the description above can be replaced by various other types of devices without detracting from the spirit of the disclosure. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method comprising:
evaluating a first worker executing a first task;
creating a first performance metric of the first worker for the first task based on the evaluation;
utilizing a task assignment system to assign a code to the first task;
storing the first performance metric of the first worker in a database of the task assignment system;
configuring the database to link the code to the first performance metric of the first worker; and
executing a task assignment procedure comprising utilizing the code to search the database and access the first performance metric of the first worker.

2. The method of claim 1, wherein the code is a machine-readable code.

3. The method of claim 2, wherein the machine-readable code is a stock keeping unit (SKU) code.

4. The method of claim 2, further comprising:
evaluating a second worker executing the first task;
creating a second performance metric of the second worker for the first task based on the evaluation;
storing the second performance metric of the second worker in the database of the task assignment system;
configuring the database to link the code to the second performance metric of the second worker; and
utilizing the code to search the database and access the second performance metric of the second worker as a part of the task assignment procedure.

5. The method of claim 4, further comprising:
utilizing the task assignment procedure to compare the first performance metric of the first worker to the second performance metric of the second worker for executing a second task that includes handling of an object that is characterized by at least one of a weight parameter, a size parameter, a portability parameter, or a damage resistance parameter.

6. The method of claim 4, further comprising:
utilizing the task assignment procedure to compare the first performance metric of the first worker to the second performance metric of the second worker for executing a second task that is defined by a numerical value indicative of a level of difficulty of executing the second task.

7. A method comprising:
assigning a machine-readable code to a first task;
evaluating a first worker executing the first task;
creating a first performance metric of the first worker for the first task based on the evaluation;
storing the first performance metric of the first worker in a database;
configuring the database to associate the machine-readable code with the first performance metric of the first worker;
evaluating a second worker executing the first task;
creating a second performance metric of the second worker for the first task based on the evaluation;
storing the second performance metric of the second worker in the database;
configuring the database to associate the machine-readable code with the second performance metric of the second worker; and
executing a task assignment procedure comprising:
utilizing the machine-readable code to search the database and access the first performance metric of the first worker and the second performance metric of the second worker; and
utilizing the first performance metric and the second performance metric to evaluate at least one of the first worker or the second worker for executing a second task.

8. The method of claim 7, wherein the machine-readable code is a stock keeping unit (SKU) code.

9. The method of claim 8, wherein the first performance metric of the first worker is characterized at least in part, by a first error rate, and the second performance metric of the second worker is characterized at least in part, by a second error rate.

10. The method of claim 9, wherein each of the first error rate and the second error rate is based at least in part, on handling of a first object when executing the first task, the first object characterized by at least one of a weight parameter, a size parameter, a portability parameter, or a damage resistance parameter.

11. The method of claim 10, wherein the second task comprises handling a second object that is substantially similar to the first object.

12. The method of claim 9, wherein each of the first error rate and the second error rate is indicative of an amount of deviation from at least one work-quality standard.

13. The method of claim 8, wherein each of the first performance metric and the second performance metric comprises a time taken to complete the first task.

14. The method of claim 8, wherein the database is located in a first computer, and wherein executing the task assignment procedure comprises:
initiating a request in a second computer;
transmitting the request from the second computer to the first computer; and
executing the task assignment procedure in one of the first computer or the second computer.

15. A non-transitory computer-readable storage medium having a computer-executable program comprising instructions for:
receiving at least a first machine-readable code, the first machine-readable code at least indicative of a characteristic of a first object or a characteristic of a first task;
utilizing the first machine-readable code to search a database, the database comprising a name of a first worker, a name of a second worker, one or more performance metrics of the first worker, and one or more performance metrics of the second worker;
comparing the one or more performance metrics of the first worker to the one or more performance metrics of the second worker; and
offering a search result that recommends utilizing one of the first worker or the second worker for at least one of handling the first object or executing the first task.

16. The non-transitory computer-readable storage medium of claim 15, wherein the first machine-readable code is a stock keeping unit (SKU) code.

17. The non-transitory computer-readable storage medium of claim 16, wherein the characteristic of the first object comprises at least one of a weight parameter, a size parameter, a portability parameter, or a damage resistance parameter.

18. The non-transitory computer-readable storage medium of claim 15, wherein the one or more performance metrics of the first worker is based on at least one performance evaluation of the first worker when the first worker is at least one of handling the first object, handling a second object, executing the first task, or executing a second task; and the one or more performance metrics of the second worker is based on at least one performance evaluation of the second worker when the second worker is at least one of handling the first object, handling the second object, executing the first task, or executing the second task.

19. The non-transitory computer-readable storage medium of claim 15, wherein the one or more performance metrics of the first worker comprises at least a first error rate that is calculated based on the first worker executing one or more previous tasks, and wherein the one or more performance metrics of the second worker comprises at least a second error rate that is calculated based on the second worker executing the one or more previous tasks.

20. The non-transitory computer-readable storage medium of claim 19, wherein each of the first error rate and the second error rate is indicative of an amount of deviation from at least one work-quality standard.
